(19) United States
(12) Patent Application Publication
(10) Pub. No.: US 2003/0011695 A1
(43) Pub. Date: Jan. 16, 2003

(54) Method and apparatus for controlling power consumption in an active pixel sensor array

(76) Inventor: Alex Roustaei, La Jolla, CA (US)

Correspondence Address: PEARNE & GORDON LLP, 526 SUPERIOR AVENUE EAST, SUITE 1200, CLEVELAND, OH, 44114-1484, US

(21) Appl. No.: 09/886,808

(22) Filed: Jun. 21, 2001

(51) Int. Cl. H04N 3/14; H04N 5/335; H04N 5/225

(52) U.S. Cl. 348/310; 348/302; 348/372

(57) ABSTRACT

The invention is directed to a method and apparatus of controlling power consumption in a CMOS active pixel sensor (APS) transducer array, which has a number of APS's arranged in columns and rows and connected to a power supply, for providing output signals representing an image and wherein the outputs of selected APS's are decimated to reduce the output bandwidth of the transducer. The method comprises the steps of determining the selected APS's having outputs that are decimated and disconnecting the selected APS's from the power supply. The decimated APS's may include some or all of the APS's located in predetermined columns, rows or columns and rows. The apparatus includes transistor switches and couplers for connecting the selected APS's to the power supply. Transistor switches may be used to connect some or all of the APS's in predetermined columns, rows or columns and rows to the power terminal or to the ground terminal of the power supply.

### FIELD OF THE INVENTION

The invention relates generally to the field of integrated electronic image sensing circuitry and more particularly to CMOS image sensors.

### BACKGROUND OF THE INVENTION

As telecommunication devices and personal digital assistants increase in popularity so do their demand for new and interesting features. Such features, which may include digital video communication or imbedded image capture apparatus, will require the use of a transducer with specifications compatible with the devices in question i.e. low power consumption, reduced size, high resolution, high speed.

Charged coupled devices (CCD) of the type disclosed in U.S. Pat. No. 3,715,485 that issued to Weimer on Feb. 6, 1973 are presently the most significant commercial IC transducer used to represent an image as an electrical signal. Complementary Metal Oxide Semiconductor Field Effect Transistor (CMOS) image sensors and CCD sensors were developed around the same time. An elementary example of a CMOS imager is described in U.S. Pat. No. 4,155,094 that issued to Ohba et al on May 15, 1979.

Although, when first developed, the CCD held a signal to noise ratio advantage over CMOS image transducers, the CMOS sensor does have certain advantages over the CCD sensor. The CMOS image sensor has the ability to integrate companion circuitry such as digital signal processing circuitry onto the same substrate as the image sensor, allowing a reduction in size of the amount of peripheral circuitry needed to interface with the image sensor. Further, integrating processing and acquisition circuitry allows designers to take advantage of a wider data path between these stages.

As well, CMOS image sensors can be manufactured using current standard CMOS fabrication techniques, giving it a significant cost advantage over using the alternative CCD image sensor, which requires special manufacturing techniques. CMOS is a less expensive technology employing fewer mask layers and is a more mature fabrication technology with greater commercial volume. CCD technology complexity causes lower fabrication yield.

Some transducer applications require less resolution than the maximum possible. In such cases it is advantageous to reduce the output bandwidth of the transducer. One technique to reduce the bandwidth of the output is to decimate or sub-sample the image. This process as described in U.S. Pat. No. 5,828,406, which issued to Parulski et al on Oct. 27, 1998, simply ignores a number of pixels in the image. For example, to perform horizontal sub-sampling or decimation by 2 the signals from the pixels of every 2^{nd} column are simply not used. One drawback to this method is that the decimated pixels are still consuming power.

Therefore, there is a need for a process and apparatus to effectively control the power consumption in CMOS image transducers that use the decimation technique to reduce the bandwidth of the image transducer.

### SUMMARY OF THE INVENTION

The invention is directed to a method of controlling power consumption in a CMOS active pixel sensor (APS) transducer array, which has a number of APS's arranged in columns and rows and connected to a power supply, for providing output signals representing an image and wherein the outputs of selected APS's are decimated to reduce the output bandwidth of the transducer. The method comprises the steps of determining the selected APS's having outputs that are decimated and disconnecting the selected APS's from the power supply. The decimated APS's may include some or all of the APS's located in predetermined columns, rows or columns and rows.

The CMOS active pixel sensor (APS) transducer array for sensing an image by providing output signals from selected APS's in accordance with the present invention comprises a number of APS's arranged in columns and rows, power terminal means adapted to be connected to a power supply, ground terminal means adapted to be connected to ground and means for connecting the selected APS's to the power terminal means and the ground terminal means.

In accordance with an aspect of this invention, the connecting means comprises switch means and coupling means whereby the switch means connects the selected APS's to the power terminal means and the coupling means connects the APS's to the ground terminal means, or whereby the switch means connects the selected APS's to the ground terminal means and the coupling means connects the APS's to the power terminal means. The selected APS's may include some or all of the APS's located in rows, columns or columns and rows.

In accordance with another aspect of this invention, the CMOS active pixel sensor (APS) transducer array for sensing an image by providing output signals from the APS's comprises a number of APS's arranged in N columns and M rows, a power terminal adapted to be connected to a power supply a ground terminal adapted to be connected to ground and means for coupling the APS's between the power terminal and the ground terminal comprising N transistors and further coupling means. Each of the N transistors may be connected between APS's in a respective column and the power terminal, or alternately connected between APS's in a respective column and the ground terminal, with the further coupling means completing the connection of the APS's to the power supply. The further coupling means may also include M transistors for completing the connection to the power supply on a row by row basis. In addition, a controller may be coupled to the transistors for selectively activating and deactivating the transistors to disconnect the power from decimated APS's

In accordance with a further aspect of this invention, the CMOS active pixel sensor (APS) transducer array for sensing an image by providing output signals from the APS's comprises a number of APS's arranged in N columns and M rows, a power terminal adapted to be connected to a power supply, a ground terminal adapted to be connected to ground and means for coupling the APS's between the power terminal and the ground terminal comprising M transistors and further coupling means. Each of the M transistors may be connected between APS's in a respective row and the power terminal, or alternately connected between APS's in a respective row and the ground terminal, with the further coupling means completing the connection of the APS's to the power supply. The further coupling means may also include N transistors for completing the connection to the power supply on a column by column basis. In addition, a controller may be coupled to the transistors for selectively activating and deactivating the transistors to disconnect the power from decimated APS's.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a basic prior art CMOS active pixel sensor (APS);

FIG. 2 illustrates a typical APS transducer array;

FIG. 3 illustrates a column of APS's;

FIG. 4 illustrates a column of APS's in accordance with the present invention;

FIG. 5 schematically illustrates transducer array columns in accordance with the present invention;

FIG. 6 schematically illustrates the circuits for generating the power enable signals for the transducer array; and

FIG. 7 illustrates a column of APS's with the grounds connected by rows in accordance with the present invention.

### DETAILED DESCRIPTION OF THE INVENTION

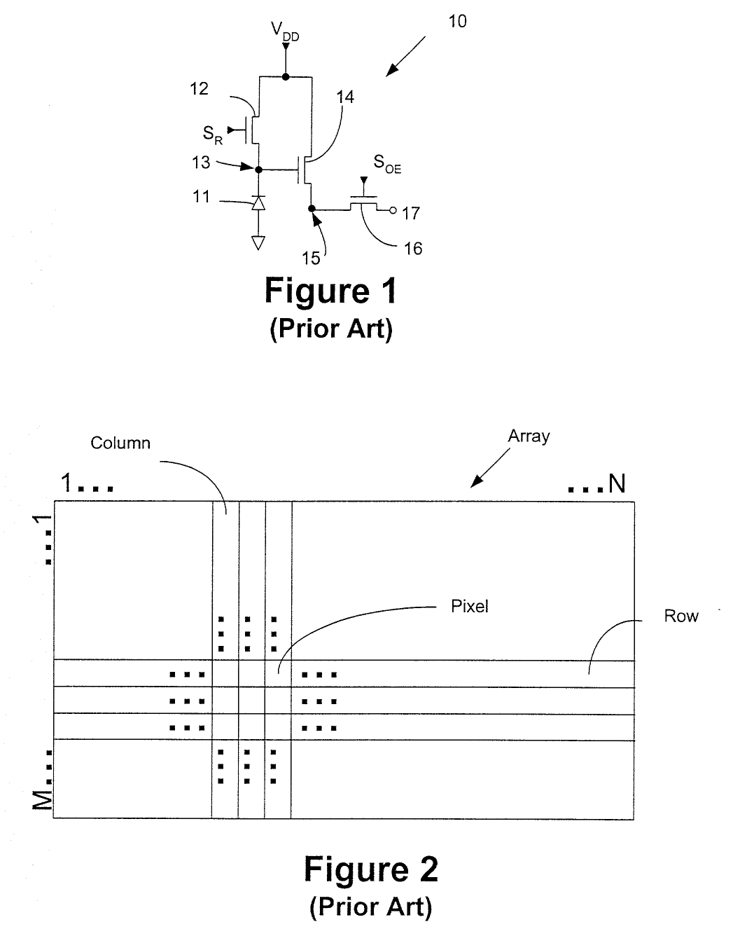

Referring to FIG. 1, a basic prior art CMOS active pixel sensor (APS) 10 is shown. This three transistor APS 10 is the simplest active sensor in the art. The photodiode 11, which is a light sensitive element, is pre-charged by a reset transistor 12 under the control of a reset signal S_{R}. This places the sensor node 11 at the power supply voltage V_{DD}. As light falls upon this diode 11, the sensor node 13 is discharged. As the sensor node 13 becomes increasingly discharged, the power transistor 14 opens and the power becomes increasingly disconnected from the output node 15. When the output enable signal SOE is activated, the output transistor 16 becomes conductive, and the amplitude of the charge placed on the column line 17 is dependent on the continuity between the power supply V_{DD} and output node 15, which is dependent on the charge on node 13.

FIG. 2 illustrates APS's 10 organized in a typical array 20, which lies in the focal plane of the transducer. The APS's 10 in array 20 are arranged in a number N of columns and a number M of rows, such that each column includes M APS's and each row includes N APS's.

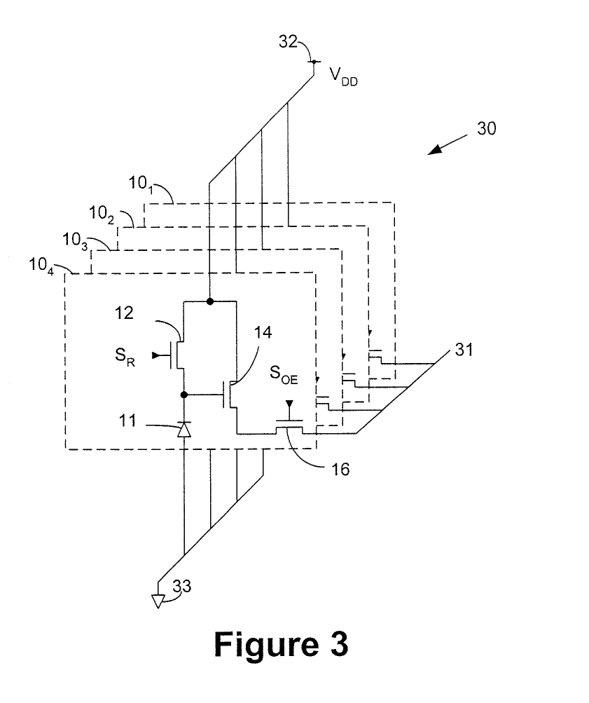

Though arrays 20 would normally include hundreds of rows and columns of APS's 10, FIG. 3 is being simplified for description purposes by illustrating a column 30 having four APS's 10₁, 10₂, 10₃ and 10₄ which are essentially identical. Each of the APS's 10₁, 10₂, 10₃ and 10₄ include a photodiode 11, a reset transistor 12, a power transistor 14 and an output transistor 16. The APS's 10₁, 10₂, 10₃ and 10₄ share a common column output 31 that in turn is connected to a column amplifier. The APS's 10₁, 10₂, 10₃ and 10₄ are supplied in parallel, between a power supply 32 voltage V_{DD} and a ground 33. In addition, each of the APS's 10₁, 10₂, 10₃ and 10₄ are reset in sequence by reset signals S_{R} applied to reset transistors 12 and are read out sequentially by output enable signals S_{OE}, applied to output transistors 16. Thus whether the output signals on line 31 are used in the processing of the image sensed by the transducer array 20 or not, it can be seen that column 30 circuitry consumes power in the process.

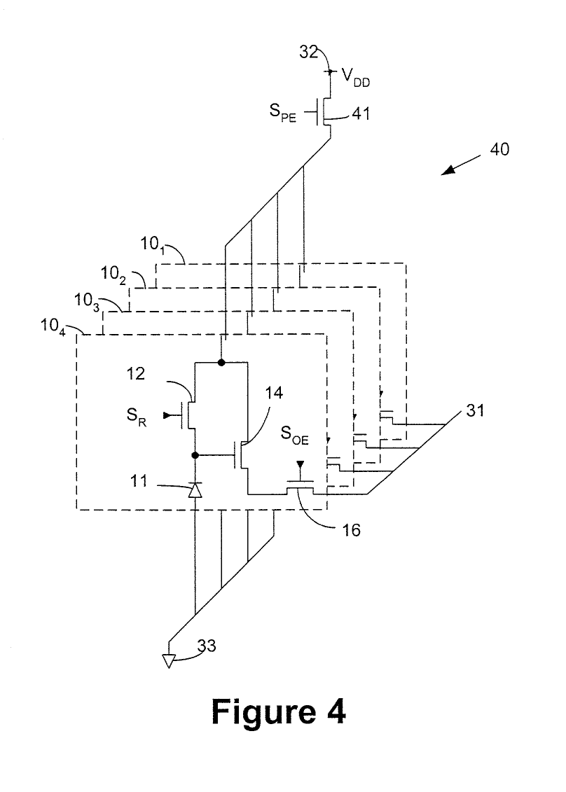

In order to preserve power during decimation in accordance with the present invention, power is cut off to columns that are decimated. FIG. 4 illustrates a column 40 in accordance with the present invention. Column 40 includes four APS's 10₁, 10₂, 10₃ and 10₄, which are essentially identical. Each of the APS's 10₁, 10₂, 10₃ and 10₄ include a photodiode 11, a reset transistor 12, a power transistor 14 and an output transistor 16. The APS's 10₁, 10₂, 10₃ and 10₄ share a common column output 31 that in turn is connected to a column amplifier. The APS's 10₁, 10₂, 10₃ and 10₄ are supplied in parallel, between a power supply 32 voltage V_{DD} and a ground 33. In addition, each of the APS's 10₁, 10₂, 10₃ and 10₄ are reset in sequence by reset signals S_{R} applied to reset transistors 12 and are read out sequentially by output enable signals S_{OE}, applied to output transistors 16. However, in this particular embodiment, a power enable transistor 41 is connected in series with the four APS's 10₁, 10₂, 10₃ and 10₄ between power 32 and ground 33. In FIG. 4, the transistor 41 is shown connected between power terminal 32 and the APS's 10₁, 10₂, 10₃ and 10₄, however, transistor 41 could equally be connected between the APS's 10₁, 10₂, 10₃ and 10₄ and ground terminal 33. Transistor 41 is responsive to a power enable signal S_{PE}. When the output signals from a particular column 40 are to be used in the processing of the image sensed by the transducer array 20, a high power enable signal S_{PE} is applied to the transistor 41 energizing the four APS's 10₁, 10₂, 10₃ and 10₄. When the output signals from a particular column 40 are not to be used in the processing of the image sensed by the transducer array 20, a low power enable signal S_{PE} is applied to the transistor 41, and the four APS's 10₁, 10₂, 10₃ and 10₄ remain de-energized preventing power consumption by the particular column 40 and therefore preserving power consumption in the transducer array 20.

Though in the above embodiment the power enable transistor 41 is described as being connected in series with a column 40 of APS's 10₁, 10₂, 10₃ and 10₄ between power terminal 32 and ground terminal 33, a row of APS's may equally be controlled in the same manner by connecting a power enable transistor in series with a row of APS's between a power terminal and ground terminal. Therefore, all further description regarding column power control is equally applicable to row power control.

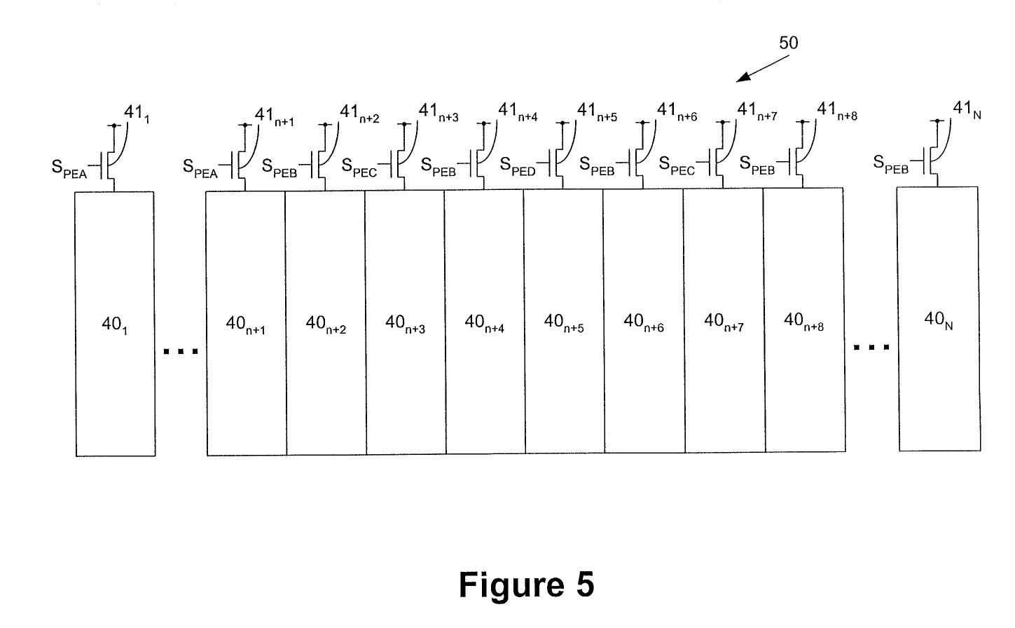

FIG. 5 schematically illustrates an array 50 of N columns in accordance with the present invention wherein it is desired to individually control the power to each of the columns 40₁ to 40_{N} so that the columns that are decimated are also de-energized. In this particular embodiment, every column 40₁ to 40_{N} has one power cutoff transistor 41₁ to 41_{N} respectively that controls the power to all of the APS's 10 in that particular column 40₁ to 40_{N}. Power enable signals S_{PE} are applied to the gates of power cutoff transistor 41₁ to 41_{N}. A controller will generate the required power enable signals S_{PE} depending on the number and type of decimation options that are to be provided by the transducer array 20. For simplicity of description only the first column 40₁, the last column 40_{N} and a set of 8 sequential columns 40ₙ₊₁ to 40ₙ₊₈ are illustrated.

The columns 40₁ to 40_{N} in the transducer array 50 may be controlled for decimation in any of a variety of ways, such as by every 2^{nd}, 3^{rd}, 4^{th}, 5^{th}, 6^{th}, 7^{th}, 8^{th}, 9^{th}, . . . column, or even by halves, thirds, fourths, fifths, sixths, sevenths, eights, ninths, . . . of each column. By way of example, an embodiment of the control of a transducer array 50 will be described in conjunction with FIG. 5 wherein the transducer array 50 is controlled such that it will allow for decimation by a factor of 1 where no decimation takes place and all columns are energized, for decimation by a factor of 2 where every second column is energized, for decimation by a factor of 4 where every fourth column is energized, and for decimation by a factor of 8 where every eighth column is energized. In this particular embodiment the number of columns N in the transducer array 50 is preferably an integer multiple of 8.

Table 1 shows the state of any set of any 8 sequential columns where the first column of the set is the (8*n+1)th column.

TABLE 1

| | | Column | | | | | | | |
|---|---|---|---|---|---|---|---|---|---|
| Decimation | Code | 8*n + 1 | 8*n + 2 | 8*n + 3 | 8*n + 4 | 8*n + 5 | 8*n + 6 | 8*n + 7 | 8*n + 8 |
| Factor | (xy) | A | B | C | B | D | B | C | B |
| 1 | 00 | ON | ON | ON | ON | ON | ON | ON | ON |
| 2 | 01 | ON | OFF | ON | OFF | ON | OFF | ON | OFF |
| 4 | 10 | ON | OFF | OFF | OFF | ON | OFF | OFF | OFF |
| 8 | 11 | ON | OFF | OFF | OFF | OFF | OFF | OFF | OFF |

In table 1, the state, ON or OFF, of the transistors for the column 40ₙ₊₁ to 40ₙ₊₈ respectively are shown for the four decimation modes illustrated. The first column 40ₙ₊₁ of the set is ON in every one of the four modes. The 2^{nd}, 4^{th}, 6^{th}, and 8^{th} columns, 40ₙ₊₂, 40ₙ₊₄, 40ₙ₊₆ and 40ₙ₊₈ respectively are only ON during mode 1 which is the non-decimation mode. The 3^{rd} and 7^{th} columns 40ₙ₊₃ and 40ₙ₊₇ respectively is ON in decimation modes 1 and 2, and the 5^{th} column 40ₙ₊₅ is ON in modes 1, 2, and 3.

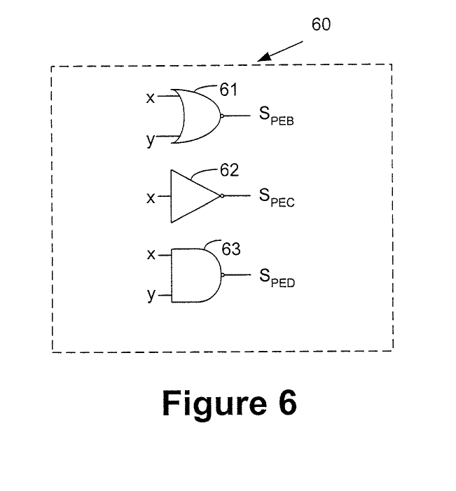

Using a two digit binary code, as shown on table 1, to implement the decimation factor in an IC, FIG. 6 illustrates circuits 60 that will properly generate the power enable signals S_{PE} associated with each of the decimation factors. Circuits 60 include an or-gate 61, an inverter 62 and an and-gate 63. These signals S_{PEA}, S_{PEB}, S_{PEC}, and S_{PED} are applied to specific column power cutoff transistors 41ₙ₊₁ to 4lₙ₊₈ as shown in table 1. Since columns 40ₙ₊₁ are always ON, the S_{PEA} signal can be tied high, or associated transistors 41ₙ₊₁ may be omitted. S_{PEB} is applied to columns 40ₙ₊₂, 40ₙ₊₄, 40ₙ₊₆ and 40ₙ₊₈, S_{PEC} is applied to columns 40ₙ₊₃ and 40ₙ₊₇ and S_{PED} is applied to columns 40ₙ₊₅.

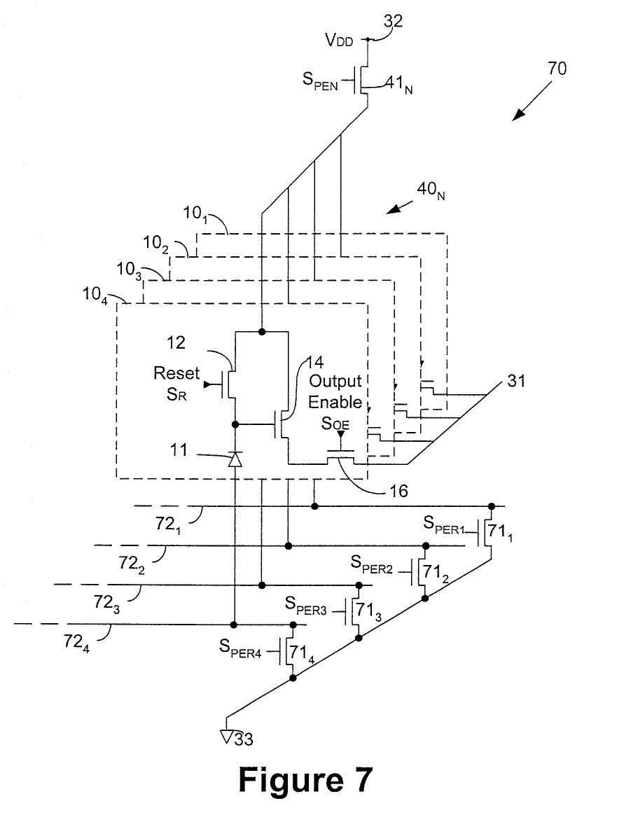

As described above, the control of power consumption by an APS transducer array may also be achieved by controlling rows of APS's. However, in addition, control may also be achieved by controlling both columns and rows simultaneously as exemplified by FIG. 7 that illustrates a small portion of an APS transducer array 70. A portion of a column 40_{N} includes four APS's 10₁, 10₂, 10₃ and 10₄, which each include a photodiode 11, a reset transistor 12, a power transistor 14 and an output transistor 16. The APS's 10₁, 10₂, 10₃ and 10₄ share a common column output 31 that in turn is connected to a column amplifier. The APS's 10₁, 10₂, 10₃, 10₄ . . . are supplied in parallel, between a power supply 32 voltage V_{DD} and a ground 33. A power enable transistor 41_{N} connected between power terminal 32 and the APS's 10₁, 10₂, 10₃, 10₄ . . . Transistor 41_{N} is responsive to a power enable column signal S_{PEN}. In addition each of the APS's 10₁, 10₂, 10₃, 10₄ . . . are connected to a ground line each ground line being common to all of the APS's in a particular row. Each of the ground line 72₁, 72₂, 72₃, 72₄ . . . are then connected to ground 33 through power enable transistors 71₁, 71₂, 71₃, 71₄ . . . respectively, which are responsive to power enable row signals S_{PER1}, S_{PER2}, S_{PER}, S_{PER4}. . . . When the output signals from the APS's in all of the columns and the rows are to be used in the processing of the image sensed by the transducer array 70, a high power enable signal S_{PEN} is applied to the transistor 41_{N} and further high power enable signals S_{PER1}, S_{PER2}, S_{PER}, S_{PER4} . . . are applied to transistors 71₁, 71₂, 71₃, 71₄ . . . energizing the APS's 10₁, 10₂, 10₃, 10₄. . . . When the output signals from a particular column 40_{N} and particular rows are not to be used in the processing of the image sensed by the transducer array 70, a low power enable signal S_{PEN} is applied to the transistor 41 and/or a low power enable signal S_{PER1}, S_{PER2}, S_{PER}, S_{PER4} . . . is applied to one or more of transistors 71₁, 71₂, 71₃, 71₄ . . . , and either the APS's 10₁, 10₂, 10₃, 10₄ . . . remain de-energized or selected APS's 10₁, 10₂, 10₃, 10₄ . . . remain de-energized, preventing power consumption by the particular APS's and therefore preserving power consumption in the transducer array 20. Using the above method, allows for power savings when using versatile and sophisticated decimation patterns.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A CMOS active pixel sensor (APS) transducer array for sensing an image by providing output signals from selected APS's comprising:
a number of APS's arranged in columns and rows;
power terminal means adapted to be connected to a power supply;
ground terminal means adapted to be connected to ground;
means for connecting the selected APS's to the power terminal means and the ground terminal means.

2. A transducer array as claimed in claim 1 wherein the connecting means comprises:
switch means for connecting the selected APS's to the power terminal means; and
coupling means for connecting the APS's to the ground terminal means.

3. A transducer array as claimed in claim 2 wherein the selected APS's are located in an array column.

4. A transducer array as claimed in claim 2 wherein the selected APS's are located in an array row.

5. A transducer array as claimed in claim 2 wherein the selected APS's are located in columns and rows of the array.

6. A transducer array as claimed in claim 2 wherein the selected APS's comprise all of the APS's located in selected array columns.

7. A transducer array as claimed in claim 2 wherein the selected APS's comprise all of the APS's located in selected array rows.

8. A transducer array as claimed in claim 1 wherein the connecting means comprises:
switch means for connecting the selected APS's to the ground terminal means; and
coupling means for connecting the APS's to the power terminal means.

9. A transducer array as claimed in claim 8 wherein the selected APS's are located in an array column.

10. A transducer array as claimed in claim 8 wherein the selected APS's are located in an array row.

11. A transducer array as claimed in claim 8 wherein the selected APS's are located in columns and rows of the array.

12. A transducer array as claimed in claim 8 wherein the selected APS's comprise all of the APS's located in selected array columns.

13. A transducer array as claimed in claim 8 wherein the selected APS's comprise all of the APS's located in selected array rows.

14. A CMOS active pixel sensor (APS) transducer array for sensing an image by providing output signals from the APS's comprising:
a number of APS's arranged in N columns and M rows;
a power terminal adapted to be connected to a power supply;
a ground terminal adapted to be connected to a ground;
means for coupling the APS's between the power terminal and the ground terminal comprising:
N transistor means wherein each of the N transistor means is connected between APS's in a respective column and the power terminal; and
further coupling means for coupling the APS's to the ground terminal.

15. A transducer array as claimed in claim 14 wherein the further coupling means comprises M transistor means wherein each of the M transistor means is connected between APS's in a respective row and the ground terminal.

16. A transducer array as claimed in claim 15 comprising control means coupled to the transistor means for selectively activating and deactivating the transistor means.

17. A CMOS active pixel sensor (APS) transducer array for sensing an image by providing output signals from the APS's comprising:
a number of APS's arranged in N columns and M rows;
a power terminal adapted to be connected to a power supply;
a ground terminal adapted to be connected to a ground;
means for coupling the APS's between the power terminal and the ground terminal comprising:
N transistor means wherein each of the N transistor means is connected between APS's in a respective column and the ground terminal; and
further coupling means for coupling the APS's to the power terminal.

18. A transducer array as claimed in claim 17 wherein the further coupling means comprises M transistor means wherein each of the M transistor means is connected between APS's in a respective row and the power terminal.

19. A transducer array as claimed in claim 18 comprising control means coupled to the transistor means for selectively activating and deactivating the transistor means.

20. A CMOS active pixel sensor (APS) transducer array for sensing an image by providing output signals from the APS's comprising:
a. a number of APS's arranged in N columns and M rows;
b. a power terminal adapted to be connected to a power supply;
c. a ground terminal adapted to be connected to a ground;
d. means for coupling the APS's between the power terminal and the ground terminal comprising:
M transistor means wherein each of the M transistor means is connected between APS's in a respective row and the power terminal; and
further coupling means for coupling the APS's to the ground terminal.

21. A transducer array as claimed in claim 20 comprising control means coupled to the transistor means for selectively activating and deactivating the transistor means.

22. A CMOS active pixel sensor (APS) transducer array for sensing an image by providing output signals from the APS's comprising:
a. a number of APS's arranged in N columns and M rows;
b. a power terminal adapted to be connected to a power supply;
c. a ground terminal adapted to be connected to a ground;
d. means for coupling the APS's between the power terminal and the ground terminal comprising:
M transistor means wherein each of the M transistor means is connected between APS's in a respective row and the ground terminal; and
further coupling means for coupling the APS's to the power terminal.

23. A transducer array as claimed in claim 20 comprising control means coupled to the transistor means for selectively activating and deactivating the transistor means.

24. In a CMOS active pixel sensor (APS) transducer array having a number of APS's arranged in columns and rows and connected to a power supply, for providing output signals representing an image and wherein the outputs of selected APS's are decimated to reduce the output bandwidth of the transducer, a method of controlling power consumption in the array comprising the steps of:
a. determining the selected APS's having outputs that are decimated; and
b. disconnecting the selected APS's from the power supply.

25. The method as claimed in claim 24 wherein the selected APS's are located in predetermined columns.

26. The method as claimed in claim 25 wherein the selected APS's are located in predetermined rows.

27. The method as claimed in claim 24 wherein the selected APS's are located in every second, second to fourth, or second to eighth columns.

28. The method as claimed in claim 24 wherein the selected APS's include all of the APS's located in predetermined columns.

29. The method as claimed in claim 28 wherein the selected APS's include all of the APS's located in predetermined rows.

30. The method as claimed in claim 24 wherein the selected APS's include all of the APS's located in predetermined rows.
